(19) United States
(12) Patent Application Publication
(10) Pub. No.: US 2022/0216658 A1
(43) Pub. Date: Jul. 7, 2022

(54) COAXIAL CABLE AND CONNECTOR ASSEMBLIES

(71) Applicant: CommScope Place SE, Hickory, NC (US)

(72) Inventor: Jeffrey D. Paynter, Momence, IL (US)

(21) Appl. No.: 17/554,563

(22) Filed: Dec. 17, 2021

Related U.S. Application Data
(60) Provisional application No. 63/133,922, filed on Jan. 5, 2021.

(51) Int. Cl. H01R 24/54; H01R 24/56; H01R 13/502; H01R 4/20

(52) U.S. Cl. CPC H01R 24/54; H01R 24/56; H01R 2103/00; H01R 4/20; H01R 13/502

(57) ABSTRACT

The present disclosure describes a coaxial cable-connector assembly. The assembly includes a coaxial cable, a coaxial connector, and a polymeric sleeve residing between an outer conductor of the cable and an outer conductor body of the connector. The polymeric sleeve is positioned to separate the electrical contact of the assembly from the mechanical contact of the assembly.

### RELATED APPLICATION(S)

The present application claims priority to and the benefit of U.S. Provisional Application Ser. No. 63/133,922, filed Jan. 5, 2021, the disclosure of which is hereby incorporated herein in its entirety.

### FIELD

The present invention relates generally to electrical cable connectors, and more particularly to coaxial connectors for electrical cables.

### BACKGROUND

Coaxial cables are commonly utilized in RF communications systems. A typical coaxial cable includes an inner conductor, an outer conductor, a dielectric layer that separates the inner and outer conductors, and a jacket that covers the outer conductor. Coaxial cable connectors may be applied to terminate coaxial cables, for example, in communications systems requiring a high level of precision and reliability.

Coaxial connector interfaces provide a connect/disconnect functionality between (a) a cable terminated with a connector bearing the desired connector interface and (b) a corresponding connector with a mating connector interface mounted on an electronic apparatus or on another cable. Typically, one connector will include a structure such as a pin or post connected to an inner conductor of the coaxial cable and an outer conductor connector body connected to the outer conductor of the coaxial cable which are mated with a mating sleeve (for the pin or post of the inner conductor) and another outer conductor connector body of a second connector. Coaxial connector interfaces often utilize a threaded coupling nut or other retainer that draws the connector interface pair into secure electro-mechanical engagement when the coupling nut (which is captured by one of the connectors) is threaded onto the other connector.

Passive Intermodulation Distortion (PIM) is a form of electrical interference/signal transmission degradation that may occur with less than symmetrical interconnections and/or as electro-mechanical interconnections shift or degrade over time. Interconnections may shift due to mechanical stress, vibration, thermal cycling, and/or material degradation. PIM can be an important interconnection quality characteristic, as PIM generated by a single low-quality interconnection may degrade the electrical performance of an entire RF system. Thus, the reduction of PIM through connector design is typically desirable.

### SUMMARY

A first aspect of the present invention is directed to a coaxial cable-connector assembly. The assembly includes (a) a coaxial cable including an inner conductor, a dielectric layer circumferentially surrounding the inner conductor; an outer conductor circumferentially surrounding the dielectric layer, and a jacket circumferentially surrounding the outer conductor; (b) a coaxial connector including an inner contact electrically connected with the inner conductor of the cable, an outer connector body spaced apart from and circumferentially surrounding the inner contact, a spring basket electrically connected with the outer conductor of the cable, wherein the spring basket is configured to mate to an inner surface of the outer conductor, and an insulator interposed between the inner contact and the outer connector body; and (c) a polymeric sleeve residing between the outer conductor of the cable and the outer connector body of the connector, the outer connector body crimped onto the polymeric sleeve, wherein the polymeric sleeve separates the spring basket from the outer conductor body to prevent direct electrical connection therebetween.

Another aspect of the present invention is directed to a coaxial cable-connector assembly. The assembly includes (a) a coaxial cable, including an inner conductor, a dielectric layer circumferentially surrounding the inner conductor, a corrugated outer conductor circumferentially surrounding the dielectric layer, and a jacket circumferentially surrounding the corrugated outer conductor; and (b) a coaxial connector including an inner contact electrically connected with the inner conductor of the cable via a first spring basket, an outer connector body spaced apart from and circumferentially surrounding the inner contact, a second spring basket electrically connected with the outer conductor of the cable, wherein the second spring basket is configured to mate to an inner surface of the outer conductor, and a polymeric insulator interposed between the inner contact and the outer connector body, wherein the inner contact is formed of a rolled sheet, the inner contact including an axial gap, and wherein polymeric material from the insulator is present within a lumen of the inner contact.

Another aspect of the present invention is directed to a coaxial cable-connector assembly. The assembly includes (a) a coaxial cable including an inner conductor, a dielectric layer circumferentially surrounding the inner conductor, an outer conductor circumferentially surrounding the dielectric layer, and a jacket circumferentially surrounding the outer conductor; (b) a coaxial connector including an inner contact electrically connected with the inner conductor of the cable, an outer connector body spaced apart from and circumferentially surrounding the inner contact and an insulator interposed between the inner contact and the outer connector body; and (c) a PIM stabilizer having a tubular main body and overlying a portion of the outer connector body and a portion of the cable, the PIM stabilizer having a first feature that engages the outer connector body and a plurality of fingers that engage the jacket of the cable to maintain the PIM stabilizer in position.

Another aspect of the present invention is directed to a method of assembling a coaxial cable-connector assembly. The method includes (a) providing a coaxial cable having an inner conductor, a dielectric layer circumferentially surrounding the inner conductor, an outer conductor circumferentially surrounding the dielectric layer, and a jacket circumferentially surrounding the outer conductor; (b) providing a coaxial connector having an inner contact, an outer connector body spaced apart from and circumferentially surrounding the inner contact, a spring basket configured to mate to an inner surface of the outer conductor, and an insulator interposed between the inner contact and the outer connector body; (c) stripping the jacket of the cable to expose a portion of the outer conductor; (d) stripping the outer conductor and dielectric layer to expose the end of the inner conductor; (e) sliding a PIM stabilizer over the end of the cable and onto an unstripped portion of the cable jacket; (f) securing a polymeric sleeve around the outer conductor; (g) sliding the connector onto the cable until a shoulder on an inner surface of the outer connector body contacts the sleeve such that the spring basket makes electrical contact with outer conductor of the cable and the inner contact make electrical contact with inner conductor of the cable; (h) crimping the outer connector body of the connector onto the sleeve; and (i) sliding the PIM stabilizer back toward the end of the cable to engage the connector.

Another aspect of the present invention is directed to a method of assembling a coaxial cable-connector assembly. The method includes (a) providing a coaxial cable having an inner conductor, a dielectric layer circumferentially surrounding the inner conductor, an outer conductor circumferentially surrounding the dielectric layer, and a jacket circumferentially surrounding the outer conductor; (b) providing an inner contact and a first insulator coupled to the inner contact; (c) providing a coaxial connector sub-assembly having an outer connector body, a spring basket configured to mate to an inner surface of the outer conductor, and a second insulator interposed radially inward of the spring basket; (d) stripping the jacket of the cable to expose a portion of the outer conductor; (e) stripping the outer conductor and dielectric layer to expose the end of the inner conductor; (f) sliding a PIM stabilizer over the end of the cable and onto an unstripped portion of the cable jacket; (g) soldering the inner contact to the inner conductor; (h) securing a polymeric sleeve around the outer conductor; (i) sliding the connector sub-assembly onto the cable until a shoulder on an inner surface of the outer connector body contacts the sleeve such that the spring basket makes electrical contact with outer conductor of the cable; (j) crimping the outer connector body of the connector onto the sleeve; and (k) sliding the PIM stabilizer back toward the end of the cable to engage the connector

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a side view of a coaxial cable-connector assembly according to embodiments of the present invention.

FIG. 2A is a side view of a connector of the coaxial cable-connector assembly of FIG. 1 according to embodiments of the present invention.

FIG. 2B is a section view of the connector of FIG. 2A.

FIG. 3A is a perspective view of a sleeve of the coaxial cable-connector assembly of FIG. 1 according to embodiments of the present invention, shown in an opened position.

FIG. 3B is a perspective view of the sleeve of FIG. 3A in a closed position.

FIG. 4 is a perspective view of a PIM stabilizer of the coaxial cable-connector assembly of FIG. 1 according to embodiments of the present invention.

FIG. 5A is a side view of a prepared cable end of the coaxial cable-connector assembly of FIG. 1 according to embodiments of the present invention.

FIG. 5B is a side view of the prepared cable end of FIG. 5A with the sleeve of FIGS. 3A-3B installed on the cable.

FIG. 6 is a side view of the connector of FIG. 2A pushed onto the prepared cable end of FIG. 5B.

FIG. 7 is a section view of the coaxial cable-connector assembly of FIG. 1.

FIG. 8 is an enlarged view of the squared section labeled “A” in FIG. 7.

FIG. 9 is a section view of an alternative coaxial cable-connector assembly according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

Low PIM with cable movement is a critical performance requirement for wireless network connectors and jumpers. Traditional methods to attach a connector to achieve this requirement involve soldering, laser welding or clamping to the outer conductor. Current pre-attached connectors typically use soldering for attachment of the connector to the cable, and field attachable connectors typically use clamping. Another desire is to reduce cost of attachment for pre-attached connectors, either from connector cost or attachment labor cost or both. The coaxial cable-connector assembly of the present invention may attain the goals of low PIM with cable movement for low-cost cables, such as jumper cables.

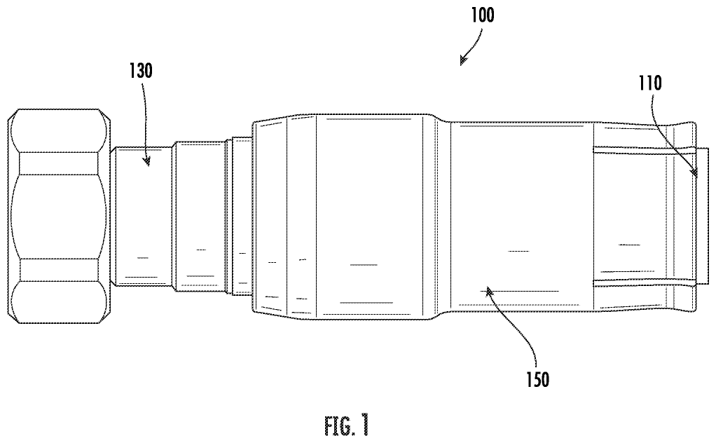

Referring now to the figures, a coaxial cable-connector assembly according to embodiments of the present invention, designated broadly at 100, is illustrated in FIGS. 1-8. As shown in FIG. 1, the assembly 100 includes a coaxial cable 110 and a connector 130 attached to one end thereof. The connector 130 may be secured to the coaxial cable 110, in part, via a PIM stabilizer 150.

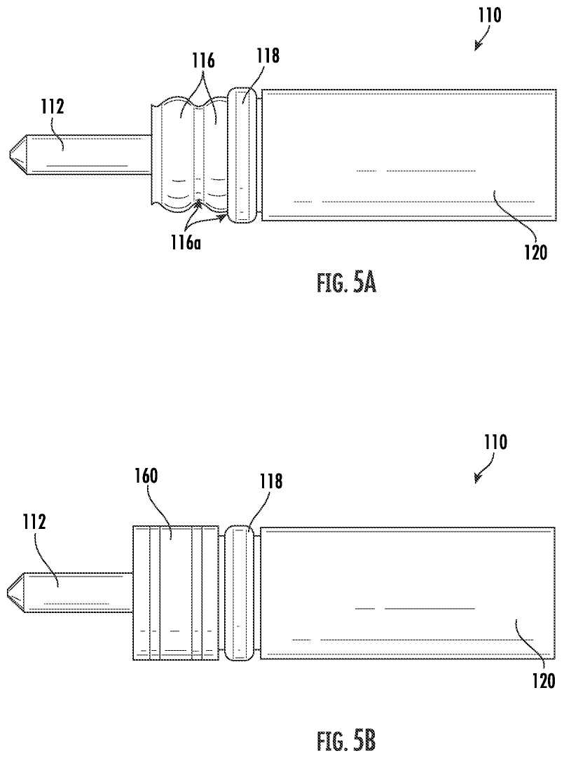

The cable 110 includes an inner conductor 112, a dielectric layer 114 that circumferentially overlies the inner conductor 112, an annularly corrugated outer conductor 116 that circumferentially overlies the dielectric layer 114, and a polymeric cable jacket 120 that circumferentially overlies the outer conductor 116 (see, e.g., FIGS. 5A-5B). These components will be well-known to those of ordinary skill in the art and need not be described in detail herein.

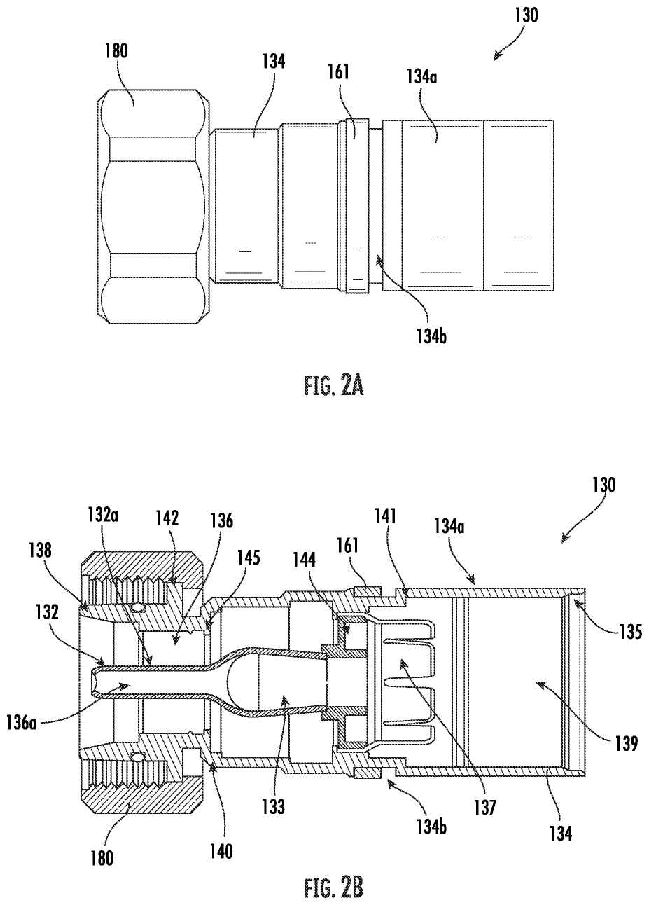

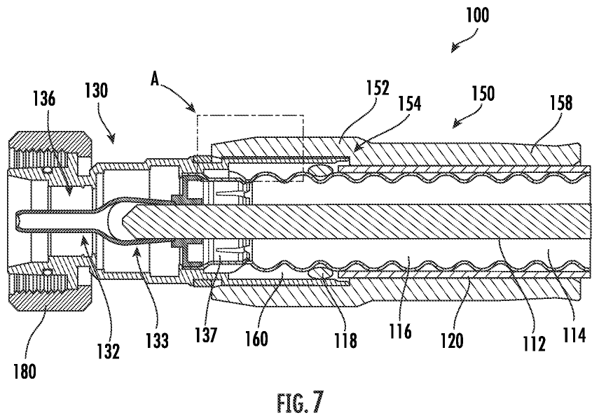

As shown in FIGS. 2A-2B, the connector 130 includes an inner contact 132, an outer connector body 134, and an insulator 136. The inner contact 132 has a generally cylindrical post 132a and is mounted on and is in electrical contact with the inner conductor 112 of the cable 110. In some embodiments, the inner contact 132 is in electrical contact with the inner conductor 112 via a spring basket 133 (see also, e.g., FIG. 7).

The outer connector body 134 includes a mating end 138 that is configured to mate with the outer conductor body of a mating jack. The mating end 138 extends forwardly from one end of a main section 140 of the outer connector body 134. In some embodiments, the mating end 138 may be tapered. A flange 142 extends radially outwardly from the main section 140 and provides a bearing surface for a coupling nut 180. At its rearward end, the outer connector body 134 has a tail section 139 that is configured to mate with the polymeric cable jacket 120 of the cable 110. A taper edge or shoulder 135 is located on an inner surface of the tail section 139 and adjacent to the open end of the tail section 139. A first recess 134a is located on an outer surface of the tail section 139. The recess 134a provides a location to crimp the connector 130 and secure the connector 130 to the cable 110.

In some embodiments, the tail section 139 of the outer connector body 134 may comprise a second shoulder 141. The second shoulder 141 may be located forwardly from the first recess 134a on an inner surface of the tail section 139. The second shoulder 141 provides a stop point and may help to prevent the connector 130 from being slid or pushed too far onto a cable 110 during assembly. A second recess 134b may be located forwardly from shoulder 141 (and recess 134a). As discussed in further detail below, the second recess 134b (in combination with the tapered edge 135) provides a location for the PIM stabilizer 150 to engage the connector 130. In some embodiments, the recess 134b is may also be configured to receive and hold an 0-ring or gasket 161.

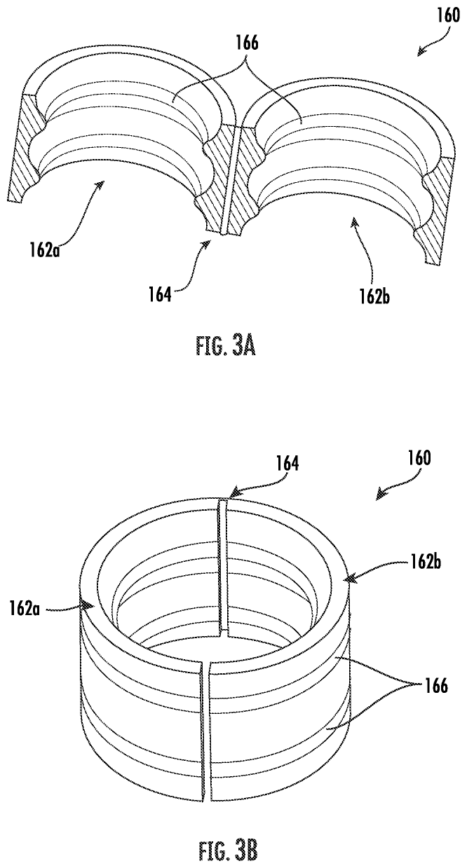

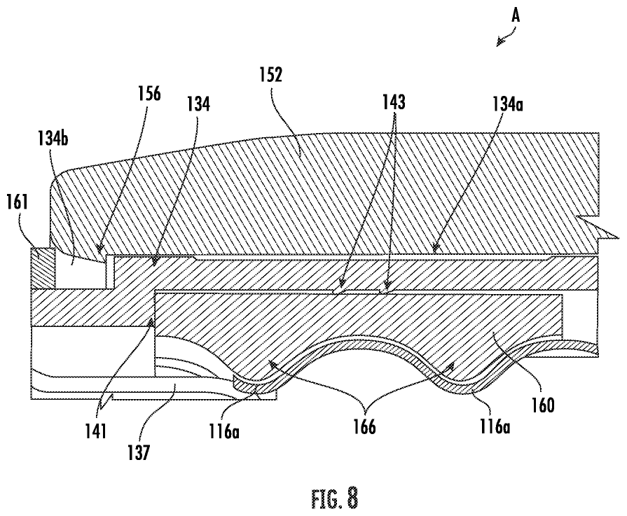

Still referring to FIGS. 2A-2B, the connector 130 further includes a second spring basket 137. The second spring basket 137 is configured to mate to the inner surface of the outer conductor 116 of the cable 110 (see also, e.g., FIG. 7). An insulator 144 is positioned radially inwardly of the forward end of the spring basket 137 and surrounds the forward end of the inner conductor 112. As described in further detail below, the fingers of the spring basket 137 and the outer conductor 116 are separated from the outer connector body 134 of the connector 130 by a sleeve 160 (FIGS. 3A-3B) that mates to the outer surface of the outer conductor 116. This configuration separates the mechanical crimp attachment (i.e., between the outer connector body 134 of the connector 130 and the cable 110) from the electrical contact (i.e., between the second spring basket 137 and the outer conductor 116, and between the spring basket 137 and the outer connector body 134) (see also, e.g., FIG. 8). Such an arrangement can improve PIM performance by eliminating potential imperfect and partial contact points which allow oxide formation and shifting contact with cable movement that can be present with conventional crimping of the outer connector body to the outer conductor of a cable.

Insulator 136 is positioned radially outwardly of the post 132a. To further reduce manufacturing costs, in some embodiments, the inner contact 132 and outer connector body 134 of the connector 130 may be made through the process of stamping and rolling. Insert molding of the insulator 136 over the inner contact 132 is a common way to produce a low-cost insulator and reduce handling during manufacture of the connector 130. Typically, with a machined inner contact 132, features are machined to allow the insulator 136 to be locked or secured to the inner contact 132 by plastic flowing into these features. In some embodiments of the present invention, the insulator 136 may be insert molded over the inner contact 132. Insulating material 136a (e.g., a polymeric material) is allowed to flow through an axial slot (not shown) from the forming process (i.e., stamping and rolling) and into a lumen of the inner contact 132. This approach allows the insulator 136 to be locked into place with the inner contact 132 without sacrificing electrical performance by adding other features for locking the insulator 136 or the additional cost of creating such features after stamping and rolling the inner contact 132. In some embodiments, the tapered spring basket 133 of the connector 130 may also be formed in the stamping design, thereby eliminating a swaging operation.

During assembly of the connector 130, the inner contact 132 (and insulator 136) will be inserted into the outer connector body 134 thru mating end 138. In some embodiments, the inner surface of the outer connector body 134 may have a shoulder 145 that provides a stop point for the insulator 136 (and inner contact 132) and help prevent the insulator 136 and inner contact 132 from being inserted too far into the outer connector body 134. The spring basket 137 will be press-fit into the outer connector body 134 through tail section 139. As the spring basket 137 also has an axial slot or gap (not shown) due to the forming process, this gap will close when being press-fit into the outer connector body 134. The outer diameter of the spring basket 137 is increased such that when this gap is closed, the interference with the outer diameter of the spring basket 137 and the receiving inner diameter of the outer connector body 134 is maintained to provide adequate pressure to maintain low PIM level. Additionally, the thickness of the spring basket 137 may be sized such that the spring basket 137 can decrease in diameter during the press-fit process while still maintaining the proper force.

Referring now to FIGS. 3A-3B, the sleeve 160 which separates the spring basket 137 from the outer connector body 134 of the connector 130 is illustrated. As shown in FIGS. 3A-3B, the sleeve 160 comprises a pair of partial tubular sections 162a, 162b. In some embodiments, the tubular sections 162a, 162b are pivotably coupled together via a living hinge 164. In some embodiments, each tubular section 162a, 162b may comprise one or more corrugations 166 that are sized and configured to cooperate or engage with the corrugated profile of the outer conductor 116 of the cable 110. For example, when the tubular sections 162a, 162b of the sleeve 160 are pivoted to a closed position (FIG. 3B) around the outer conductor 116 of the cable 110, the corrugations 166 of the sleeve 160 are configured to engage the corrugated outer conductor 116, thereby securing the sleeve 160 around the outer conductor 116 of the cable 110 (see also, e.g., FIG. 5B and FIG. 8).

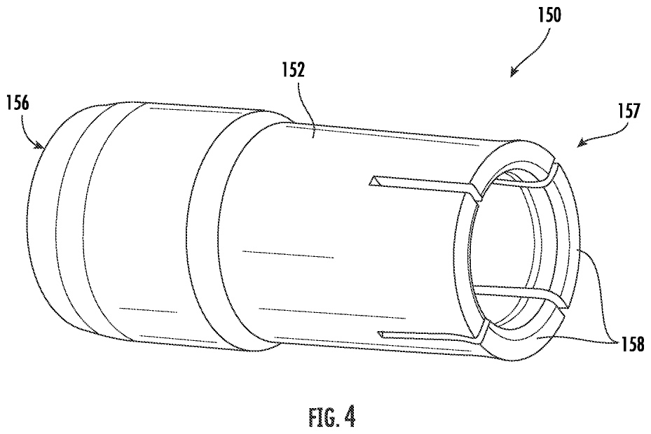

It has been found that an effective mitigation to PIM with cable movement involves shifting the point of the cable 110 bending away from the interface. According to embodiments of the present invention, this may be accomplished by utilizing the PIM stabilizer 150, which is illustrated in FIG. 4.

The PIM stabilizer 150 of the present invention comprises a tubular main body 152. In some embodiments, the main body 152 is formed of a polymeric material, e.g., plastic. At one end of the tubular main body 152 is a projection or flanged edge 156. The projection 156 is configured to snap over or be received by a feature on the outer connector body 134 of the connector 130 (e.g., recess 134b) (see, e.g., FIGS. 7-8). The tubular main body 152 of the PIM stabilizer 150 further comprises a second point of contact (e.g., a notch or tapered edge 154) on its inner surface. The notch or tapered edge 154 is configured to mate with a corresponding feature on the tail section 139 of the outer connector body 134 (e.g., tapered edge or shoulder 135) (see, e.g., FIG. 7). This configuration provides a stable mechanical structure to support the PIM stabilizer 150 and passes mechanical moment and stresses from bending of the cable 110 away from the interface of the connector 130.

A common difficulty has been experienced in other types of stabilizers with regard to making a tight contact with the cable jacket 120 because the cable jacket tolerance is quite wide. To overcome these difficulties, the PIM stabilizer 150 of the present invention further comprises a spring basket 158 with axial slots 157 at the opposing end of the tubular main body 152 (i.e., opposite from the end with projection 156). The end of the tubular main body 152 (i.e., spring basket 158) is sized to provide interference with the minimum outer diameter of the cable jacket 120. The slots 157 and flexibility of the polymeric tubular main body 152 allows the spring basket 158 to accommodate a larger cable jacket 120 outer diameter by flexing outward. The length, width, and number of slots 157, as well as the cross-section thickness at the slot root, can be varied to create the proper force against the cable jacket 120. In some embodiments, the coaxial cable-connector assembly 100 of the present invention may be installed in a controlled environment. Accordingly, a special tool may be used to provide adequate force to advance the PIM stabilizer 150 along the cable 110 and snap the PIM stabilizer 150 into place on the outer connector body 134 of the connector 130, thereby allowing a much greater interference than if limited to hand force as with a typical field fit type connector.

Assembly of the coaxial cable-connector assembly 100 commences with the preparation of the cable 110, which comprises stripping the cable jacket 120 to expose a portion of the outer conductor 116. Additionally, the outer conductor 116 and dielectric layer 114 are stripped to expose the end of the inner conductor 112 (FIG. 5A). As shown in FIG. 5A, an 0-ring 118 is slipped over the end of the cable 110 and into a “valley” 116a of the corrugations of the outer conductor 116. The O-ring 118 is positioned in the valley 116a that is adjacent to the stripped cable jacket 120. Next, the sleeve 160 is secured around the outer conductor 116 of the cable 110 such that the corrugations 166 of the sleeve 160 engage the corrugations of the outer conductor 116 (FIG. 5B).

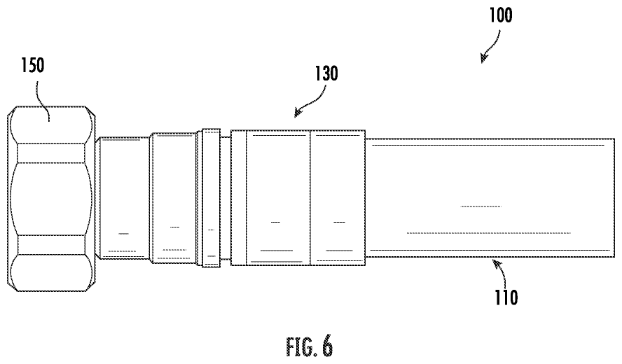

As shown in FIG. 6, the connector 130 comprising the outer connector body 134, the inner contact 132, insulator 136, insulator 144, spring baskets 133, 137, and coupling nut 180 is then slipped over the prepared end of the cable 110. The connector 130 is slid onto the cable 110 until spring basket 137 contacts the outer conductor 116 of the cable 110 and spring basket 133 engages the inner conductor 112 of the cable 110 (see, e.g., FIG. 7). As shown in FIG. 8, in some embodiments, the shoulder 141 of the outer connector body 134 contacts the sleeve 160 to help prevent the connector 130 from being slid or pushed too far onto the cable 110.

Once the connector 130 is positioned on the cable 110, the connector 130 may be secured to the cable 110 by crimping the outer connector body 134 within recess 134a. While many known coaxial connectors use crimp for cable attachment, PIM performance may not be good due to imperfect and partial contact points which allow oxide formation and shifting contact with cable movement. As shown in FIG. 7 and FIG. 8, according to embodiments of the present invention, the mechanical crimp attachment is separated from the electrical contact at the outer connector body 134 by means of the outer electrical spring basket 137 mating to the inside of the outer conductor 116 of the cable 110. The spring basket 137 is separated from the outer connector body 134 of the connector 130 at this location by the sleeve 160 that mates to the outer connector body 134. The outer connector body 134 of the connector 130 is crimped over the sleeve 160 (i.e., within recess 134a) to provide retention and mechanical attachment.

During crimp, in some embodiments, barbs 143 on the inner surface of the outer connector body 134 (below recess 134a) may press into the sleeve 160 to provide pull-off resistance with the outer connector body 134. The corrugation fitting profile of the sleeve 160 provides pull-off resistance with the cable 110. This combination locks the connector 130 to the cable 110. Since the sleeve 160 is made of a polymeric material (e.g., plastic), electrical contact between the outer conductor 116 of the cable 110 and the outer connector body 134 is prevented at that location. Instead, electrical contact is made between the outer conductor 116 and the spring basket 137, and then between the spring basket 137 and the outer connector body 134 away from the crimping location (i.e., near insulator 144). As a result, the radial contact provides a good PIM performance and is isolated from the mechanical attachment.

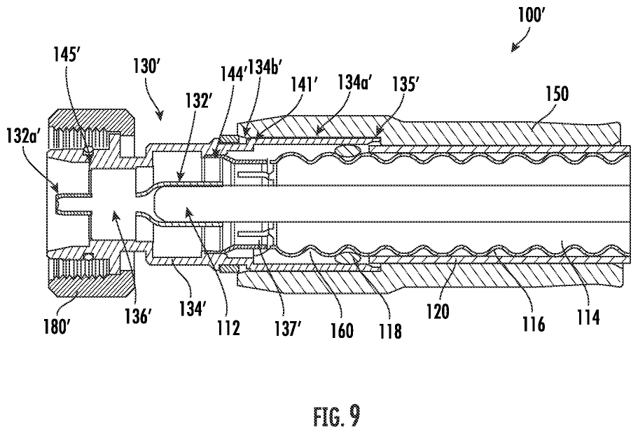

Referring now to FIG. 9, an alternative coaxial cable-connector assembly 100′ according to embodiments of the present invention is illustrated. Properties and/or features of the coaxial cable-connector assembly 100′ may be as described above in reference to the assembly 100 shown in FIGS. 1-8 and duplicate discussion thereof may be omitted herein for the purposes of discussing FIG. 9.

As shown in FIG. 9, the coaxial cable-connector assembly 100′ differs from assembly 100 in that the connector 130′ does not include the first spring basket 133. Instead, the inner contact 132′ of the connector 130′ is secured to the inner conductor 112 of the cable 110 via soldering. The remaining features of the coaxial cable-connector assembly 100′ are similar to those described herein with respect to assembly 100.

Assembly of the coaxial cable-connector assembly 100′ is slightly different than assembly 100. Preparation of the cable 110 is the same as describe above and illustrated in FIGS. 5A-5B. After the cable 110 has been prepared, the inner contact 132′ (with insulator 136′) is soldered to the inner conductor 112 of the cable 110. The connector 130′ comprising the outer connector body 134′, insulator 144′, spring basket 137′, and coupling nut 180′ is then slipped over the prepared end of the cable 110 with the inner contact 132 and insulator 136. The connector 130′ is slid onto the cable 110 until spring basket 137′ contacts the outer conductor 116 of the cable 110 and a shoulder 145′ contacts the insulator 136′. In some embodiments, shoulder 141′ of the outer connector body 134′ contacts the sleeve 160 to help prevent the connector 130 from being slid or pushed too far onto the cable 110.

Once the connector 130′ is positioned on the cable 110, the connector 130′ may be secured to the cable 110 in the same manner as described herein with respect to assembly 100 (i.e., by crimping the outer connector body 134′. Similar to assembly 100, in assembly 100′ , the mechanical crimp attachment is separated from the electrical contact at the outer connector body 134′ by means of the outer electrical spring basket 137′ which mates to the inside of the outer conductor 116 of the cable 110. The spring basket 137′ is separated from the outer connector body 134′ of the connector 130 at this location by the sleeve 160 that mates to the outer connector body 134′. The outer connector body 134′ of the connector 130′ is crimped over the sleeve 160 (i.e., within recess 134a′) to provide retention and mechanical attachment.

Assembly of the coaxial cable-connector assemblies 100,100′ of the present invention is intended to reduce attachment complexity and thus labor cost, allowing the attachment to be moved from a factory setting and to a store-front type low overhead facility.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A coaxial cable-connector assembly, comprising:
(a) a coaxial cable, comprising:
an inner conductor;
a dielectric layer circumferentially surrounding the inner conductor;
an outer conductor circumferentially surrounding the dielectric layer; and
a jacket circumferentially surrounding the outer conductor;
(b) a coaxial connector, comprising:
an inner contact electrically connected with the inner conductor of the cable;
an outer connector body spaced apart from and circumferentially surrounding the inner contact;
a spring basket electrically connected with the outer conductor of the cable, wherein the spring basket is configured to mate to an inner surface of the outer conductor; and
an insulator interposed between the inner contact and the outer connector body; and
(c) a polymeric sleeve residing between the outer conductor of the cable and the outer connector body of the connector, the outer connector body crimped onto the polymeric sleeve, wherein the polymeric sleeve separates the spring basket from the outer conductor body to prevent direct electrical connection therebetween.

2. The coaxial cable-connector assembly of claim 1, further comprising a PIM stabilizer having a tubular main body and overlying a portion of the outer connector body and a portion of the cable.

3. The coaxial cable-connector assembly of claim 1, wherein the inner contact is electrically connected with the inner conductor of the cable via a second spring basket.

4. The coaxial cable-connector assembly of claim 1, wherein the inner contact is electrically connected with the inner conductor of the cable via soldering.

5. The coaxial cable-connector assembly of claim 1, wherein the outer conductor comprises a plurality of corrugations, and wherein the sleeve has a corrugation fitting profile that engages one or more of the corrugations of the outer conductor.

6. The coaxial cable-connector assembly of claim 2, wherein the main body of the PIM stabilizer comprises a flanged edge and a tapered edge and the outer connector body of the connector comprises a recess and a tapered edge, and wherein the flanged edge and tapered edge of the PIM stabilizer are configured to engage, respectively, the recess and tapered edge of the outer connector body to secure the PIM stabilizer to the connector.

7. The coaxial cable-connector assembly of claim 1, wherein the end of the tubular main body includes a spring basket sized and configured to provide interference with the minimum outer diameter of the cable jacket.

8. The coaxial cable-connector assembly of claim 1, wherein the outer connector body of the connector comprises a second recess providing a location to crimp the connector and secure the connector to the cable.

9. The coaxial cable-connector assembly of claim 1, wherein the connector further comprises a shoulder on an inner surface of the outer connector body, the shoulder positioned to prevent the connector from being slid too far onto the cable during assembly.

10. The coaxial cable-connector assembly of claim 1, wherein the sleeve comprises a pair of partial tubular sections pivotably coupled together via a living hinge.

11. The coaxial cable-connector assembly of any claim 1, wherein the inner contact and outer connector body of the connector are formed by a process of stamping and rolling.

12. The coaxial cable-connector assembly of claim 1, wherein the insulator is insert molded over the inner contact to allow insulating material to flow through an axial slot into the inside of the inner contact, thereby locking the insulator into place with the inner contact.

13. The coaxial cable-connector assembly of claim 1, wherein the sleeve is configured and positioned to prevent electrical contact between the outer conductor of the cable and the outer connector body of the connector.

14.-25. (canceled)

26. A coaxial cable-connector assembly, comprising:
(a) a coaxial cable, comprising:
an inner conductor;
a dielectric layer circumferentially surrounding the inner conductor;
an outer conductor circumferentially surrounding the dielectric layer; and
a jacket circumferentially surrounding the outer conductor;
(b) a coaxial connector, comprising:
an inner contact electrically connected with the inner conductor of the cable;
an outer connector body spaced apart from and circumferentially surrounding the inner contact; and
an insulator interposed between the inner contact and the outer connector body; and
(c) a PIM stabilizer having a tubular main body and overlying a portion of the outer connector body and a portion of the cable, the PIM stabilizer having a first feature that engages the outer connector body and a plurality of fingers that engage the jacket of the cable to maintain the PIM stabilizer in position.

27. The coaxial cable-connector assembly of claim 26, wherein the outer conductor comprises a plurality of corrugations, and the assembly further comprises a polymeric sleeve having a corrugation fitting profile that engages one or more of the corrugations of the outer conductor.

28. The coaxial cable-connector assembly of claim 27, wherein the polymeric sleeve separates the spring basket from the outer conductor body to prevent direct electrical connection therebetween.

29. The coaxial cable-connector assembly of claim 26, wherein the outer connector body of the connector comprises a recess providing a location to crimp the connector and secure the connector to the cable.

30. The coaxial cable-connector assembly of claim 26, wherein the connector further comprises a shoulder on an inner surface of the outer connector body, the shoulder positioned to prevent the connector from being slid too far onto the cable during assembly.

31. The coaxial cable-connector assembly of claim 27, wherein the sleeve comprises a pair of partial tubular sections pivotably coupled together via a living hinge.

32.-33. (canceled)

34. A method of assembling a coaxial cable-connector assembly, the method comprising:
providing a coaxial cable having an inner conductor, a dielectric layer circumferentially surrounding the inner conductor, an outer conductor circumferentially surrounding the dielectric layer, and a jacket circumferentially surrounding the outer conductor;
providing a coaxial connector having an inner contact, an outer connector body spaced apart from and circumferentially surrounding the inner contact, a spring basket configured to mate to an inner surface of the outer conductor, and an insulator interposed between the inner contact and the outer connector body;
stripping the jacket of the cable to expose a portion of the outer conductor;
stripping the outer conductor and dielectric layer to expose the end of the inner conductor;
sliding a PIM stabilizer over the end of the cable and onto an unstripped portion of the cable jacket;
securing a polymeric sleeve around the outer conductor;
sliding the connector onto the cable until a shoulder on an inner surface of the outer connector body contacts the sleeve such that the spring basket makes electrical contact with outer conductor of the cable and the inner contact make electrical contact with inner conductor of the cable;
crimping the outer connector body of the connector onto the sleeve; and
sliding the PIM stabilizer back toward the end of the cable to engage the connector.

35. (canceled)
